(19) United States
(12) Patent Application Publication
(10) Pub. No.: US 2026/0073731 A1
(43) Pub. Date: Mar. 12, 2026

(54) SELECTING COMBINATION OF PARAMETERS FOR PREPROCESSING FACIAL IMAGES OF WEARER OF HEAD-MOUNTABLE DISPLAY

(71) Applicant: Hewlett-Packard Development Company, L.P., Spring, TX (US)

(72) Inventors: Shibo Zhang, Palo Alto, CA (US); Jishang Wei, Guilford, CT (US); Prahalathan Sundaramoorthy, Palo Alto, CA (US)

(73) Assignee: Hewlett-Packard Development Company, L.P., Spring, TX (US)

(21) Appl. No.: 19/106,147

(22) PCT Filed: Aug. 31, 2022
(86) PCT No.: PCT/US2022/042226

§ 371 Date: Feb. 24, 2025

(51) Int. Cl. G06V 40/16; G06T 13/40; G06V 10/74

(52) U.S. Cl. CPC G06V 40/171; G06T 13/40; G06V 10/761; G06V 40/166; G06V 40/176

(57) ABSTRACT

For each facial image of a wearer of a head-mountable display (HMD), preprocessed facial images corresponding to combinations of preprocessing parameters are generated. A machine learning model is applied to each preprocessed facial image to predict facial action units. The facial action units predicted from each preprocessed facial image are retargeted onto an avatar to render an avatar facial image. Avatar facial landmarks within each avatar facial image and wearer facial landmarks within each facial image are detected. The combination of preprocessing parameters yielding a highest similarity between the avatar facial landmarks and the wearer facial landmarks corresponding to the avatar facial landmarks is selected.

### BACKGROUND

Extended reality (XR) technologies include virtual reality (VR), augmented reality (AR), and mixed reality (MR) technologies, and quite literally extend the reality that users experience. XR technologies may employ head-mountable displays (HMDs). An HMD is a display device that can be worn on the head. In VR technologies, the HMD wearer is immersed in an entirely virtual world, whereas in AR technologies, the HMD wearer's direct or indirect view of the physical, real-world environment is augmented. In MR, or hybrid reality, technologies, the HMD wearer experiences the merging of real and virtual worlds.

### BRIEF DESCRIPTION OF THE DRAWINGS

FIGS. 1A and 1B are perspective and front view diagrams, respectively, of an example head-mountable display (HMD) that can be used in an extended reality (XR) environment.

FIG. 2 is a diagram of an example process for predicting facial action units for a facial expression of the wearer of an HMD from facial images of the wearer captured by the HMD after preprocessing the images.

FIGS. 3A, 3B, and 3C are diagrams of example facial images of the wearer of an HMD captured by the HMD, on which basis facial action units for the wearer's facial expression can be predicted.

FIG. 4 is a diagram of an example avatar that can be rendered to have the facial expression of the wearer of an HMD based on facial action units predicted for the wearer's facial expression.

FIG. 5 is a diagram of an example process for selecting a combination of parameters for preprocessing facial images that a machine learning model can then use to predict facial action units in FIG. 2.

FIG. 6 is a flowchart of an example method for acquiring facial calibration images that can be used in the process of FIG. 5.

FIG. 7 is a diagram of example facial landmarks that can be detected within a facial image of the wearer of an HMD or within an image of a rendered avatar corresponding to the wearer in the process of FIG. 5.

FIG. 8 is a diagram of an example non-transitory computer-readable data storage medium.

FIG. 9 is a flowchart of an example method.

FIG. 10 is a block diagram of an example system including an HMD.

### DETAILED DESCRIPTION

As noted in the background, a head-mountable display (HMD) can be employed as an extended reality (XR) technology to extend the reality experienced by the HMD's wearer. An HMD can include one or multiple small display panels in front of the wearer's eyes, as well as various sensors to detect or sense the wearer and/or the wearer's environment. Images on the display panels convincingly immerse the wearer within an XR environment, be it a virtual reality (VR), augmented reality (AR), a mixed reality (MR), or another type of XR.

An HMD can include one or multiple cameras, which are image-capturing devices that capture still or motion images. For example, one camera of an HMD may be employed to capture images of the wearer's lower face, including the mouth. Two other cameras of the HMD may each be employed to capture images of a respective eye of the HMD wearer and a portion of the wearer's face surrounding the eye.

In some XR applications, the wearer of an HMD can be represented within the XR environment by an avatar. An avatar is a graphical representation of the wearer or the wearer's persona, may be in three-dimensional (3D) form, and may have varying degrees of realism, from cartoonish to nearly lifelike. For example, if the HMD wearer is participating in an XR environment with other users wearing their own HMDs, the avatar representing the HMD wearer may be displayed on the HMDs of these other users.

The avatar can have a face corresponding to the face of the wearer of the HMD. To represent the HMD wearer more realistically, the avatar may have a facial expression in correspondence with the wearer's facial expression. The facial expression of the HMD wearer thus has to be determined before the avatar can be rendered to exhibit the same facial expression.

A facial expression can be defined by a set of facial action units of a facial action coding system (FACS). A FACS taxonomizes human facial movements by their appearance on the face, via values, weights, or units, for different facial actions. Facial actions may also be referred to as blendshapes and/or descriptors, and the units may also be referred to as intensities. Individual facial actions can correspond to particular contractions or relaxations of one or more muscles, for instance. Any anatomically possible facial expression can thus be deconstructed into or coded as a set of facial action units representing the facial expression. It is noted that in some instances, facial expressions can be defined using facial action units that are not specified by the FACS.

Facial avatars can be rendered to have a particular facial expression based on the facial action units of that facial expression. That is, specifying the facial action units for a particular facial expression allows for a facial avatar to be rendered that has the facial expression in question. This means that if the facial action units of the wearer of an HMD are able to be identified, a facial avatar exhibiting the same facial expression as the HMD wearer can be rendered and displayed. One way to identify the facial action units of the wearer of an HMD is to employ a machine learning model that predicts the facial action units of the wearer's current facial expression from facial images of the wearer that have been captured by the HMD.

To improve the accuracy of the machine learning model, the facial images of the HMD wearer may be preprocessed before applying the model. Preprocessing the captured wearer facial images can permit the machine learning model to more easily extract image features on which basis the model predicts facial action units. An example preprocessing technique is contrast-limited adaptive histogram equalization (CLAHE). CLAHE improves contrast within images. The technique is adaptive in that different images (and more specifically, different regions of an image) may have their contrast amplified by different amounts. The technique is contrast-limited to limit the amount of contrast amplification in any region of an image.

CLAHE has a number of tunable preprocessing parameters, namely grid size and clip limit. Grid size is the size of the grid that is used for equalization. An image is divided over a grid of equally sized rectangular regions, and grid size parameter specifies both the size of this grid. Grid size can be specified as an integer between 2 (correspond to the smallest grid size and thus the largest number of regions) to 32 (correspond to the largest grid size and thus the smallest number of regions). Clip limit is a contrast-limiting threshold, which is the maximum amount by which contrast can be amplified in each region. Clip limit can be specified as an integer from 0 (corresponding to the smallest limit) to 10 (corresponding to the greatest limit).

The combination of preprocessing parameters that results in a machine learning model predicting facial action units that best correspond to an HMD wearer's facial expression within facial images can vary by wearer and based on the lighting conditions under which the images are captured. For instance, preprocessing facial images of a first wearer captured under initial lighting conditions using a given combination of parameters may result in the most accurate prediction when the model is applied to the images.

By comparison, the most accurate prediction when the first wearer's facial images are captured under different lighting conditions may result when the images are preprocessed using a different combination of parameters than those used during the initial lighting conditions. Similarly, the most accurate prediction for a second wearer may result when the second wearer's facial images are preprocessed using a different combination than those used for the first wearer, even if the images are captured under the same lighting conditions.

Techniques described herein select the combination of preprocessing parameters that are more likely to result in a machine learning model predicting facial action units that most accurately reflect the facial expression that an HMD wearer exhibits in captured facial images. The captured facial images are preprocessed using the selected combination of parameters prior to application of the model. The combination of preprocessing parameters may be selected the first time the wearer uses the HMD. The parameters combination may be reselected when lighting conditions under which the HMD captures facial images of the wearer change, either automatically or by the user manually reinitiating the selection process.

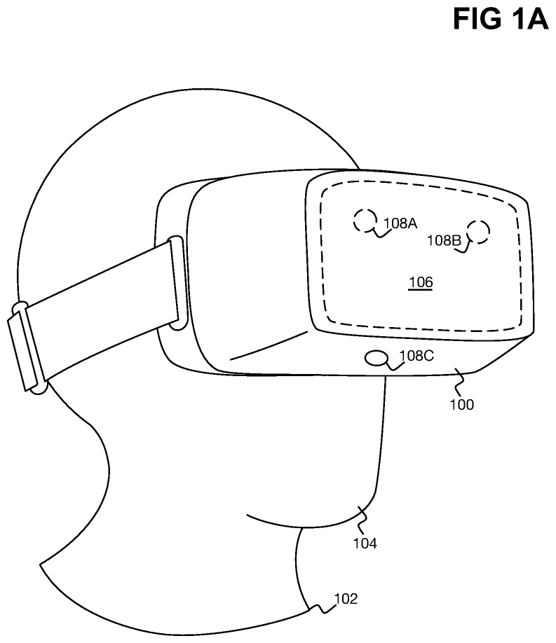

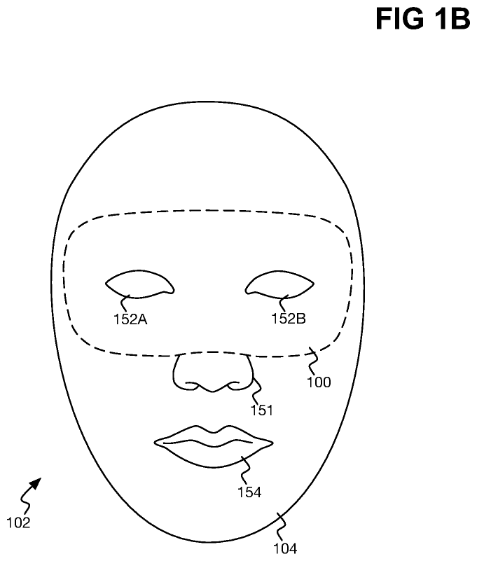

FIGS. 1A and 1B show perspective and front view diagrams of an example HMD 100 worn by a wearer 102 and positioned against the face 104 of the wearer 102 at one end of the HMD 100. Specifically, the HMD 100 can be positioned above the wearer 102's nose 151 and around his or her right and left eyes 152A and 152B, collectively referred to as the eyes 152 (per FIG. 1B). The HMD 100 can include a display panel 106 inside the other end of the HMD 100 that is positionable incident to the eyes 152 of the wearer 102. The display panel 106 may in actuality include a right display panel incident to and viewable by the wearer 102's right eye 152A, and a left display panel incident to and viewable by the wearer 102's left eye 152B. By suitably displaying images on the display panel 106, the HMD 100 can immerse the wearer 102 within an XR.

The HMD 100 can include eye camera 108A and 108B and/or a mouth camera 108C, which are collectively referred to as the cameras 108C. While just one mouth camera 108C is shown, there may be multiple mouth cameras 108C. Similarly, whereas just one eye camera 108A and one eye camera 108B are shown, there may be multiple eye cameras 108A and/or multiple eye cameras 108B. The cameras 108 capture images of different portions of the face 104 of the wearer 102 of the HMD 100, on which basis the facial action units for the facial expression of the wearer 102 can be predicted.

The eye cameras 108A and 108B are inside the HMD 100 and are directed towards respective eyes 152. The right eye camera 108A captures images of the facial portion including and around the wearer 102's right eye 152A, whereas the left eye camera 108B captures images of the facial portion including and around the wearer 102's left eye 152B. The mouth camera 108C is exposed at the outside of the HMD 100, and is directed towards the mouth 154 of the wearer 102 (per FIG. 1B) to capture images of a lower facial portion including and around the wearer 102's mouth 154.

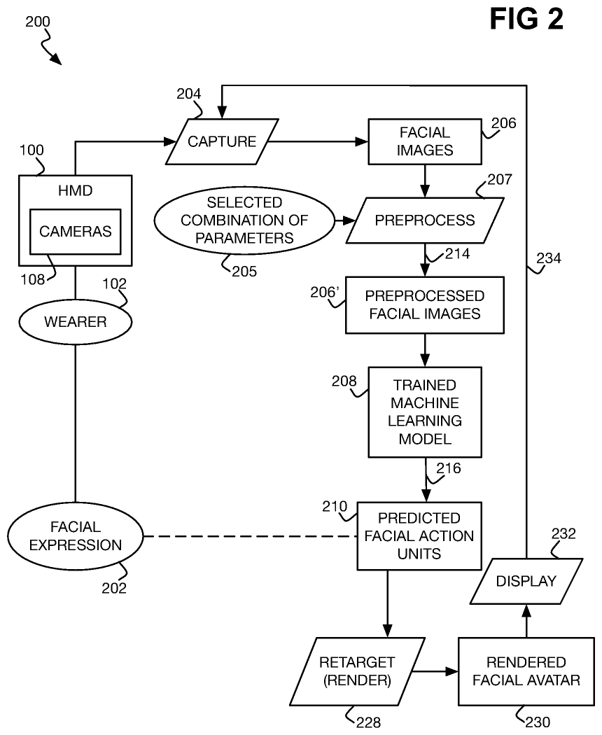

FIG. 2 shows an example process 200 for predicting facial action units for the facial expression of the wearer 102 of the HMD 100, which can then be retargeted onto an avatar corresponding to the wearer 102's face to render the avatar with a corresponding facial expression. The cameras 108 of the HMD 100 capture (204) a set of facial images 206 of the wearer 102 of the HMD 100 (i.e., a set of images 206 of the wearer 102's face 104), who is currently exhibiting a given facial expression 202. A trained machine learning model 208 is applied to the facial images 206 to predict facial action units 210 for the wearer 102's facial expression 202.

The machine learning model 208 may itself be or include a convolutional neural network having convolutional layers followed by a pooling layer that generate, identify, or extract image features to predict facial action units from input images. Examples include different versions of the MobileNet machine learning model. The MobileNet machine learning model is described in A. Howard et al., “MobileNets: Efficient Convolutional Neural Networks for Mobile Vision Applications,” arXiv: 1704.04861 [cs. CV], April 2017; M. Sandler et al. “MobileNetV2: Inverted Residuals and Linear Bottlenecks,” arXiv: 1801.104381 [cs. CV], March 2019; and A. Howard et al., “Search for MobileNetV3,” arXiv: 1905.02244 [cs. CV], November 2019.

However, prior to application of the trained machine learning model 208 to the captured facial images 206, the facial images 206 undergo preprocessing using a selected combination 205 of preprocessing parameters (207), yielding preprocessed facial images 206′ to which the model 208 is actually applied. For example, preprocessing may include applying an image-preprocessing technique such as CLAHE to the facial images 206 to generate the preprocessed facial images 206′. In one implementation, the Open Source Computer Vision (OpenCV) implementation of CLAHE described at docs.opencv.org/4.x/d5/daf/tutorial_py_histogram_equalization.html may be employed. In this case, the combination 205 of parameters can include a particular value for clip limit, such as an integer between 0 and 10, and a particular for grid size, such as an integer between 2 and 32.

The selected preprocessing parameters combination 205 is specific to the wearer 102 of the HMD 100, and thus differs depending on the user who is currently the wearer 102. The selected combination 205 may also be specific to the lighting conditions under which facial images 206 are captured. The parameters combination 205 for the wearer 102 may be selected under initial lighting conditions, and when the lighting conditions change, the combination 205 may be reselected either automatically or at behest of the wearer 102. How the combination 205 of parameters is selected is described later in the detailed description.

The set of preprocessed facial images 206′ is thus input (214) into the trained machine learning model 208, with the model 208 then outputting (216) predicted facial action units 210 for the facial expression 202 of the wearer 102 based on the facial images 206′. The trained machine learning model 208 may also output a predicted facial expression based on the facial images 206′, which corresponds to the wearer 102's actual currently exhibited facial expression 202.

In one implementation, the machine learning model 208 may be a two-stage machine learning model. The first stage may be a backbone network, such as a convolutional neural network (e.g., a version of the MobileNet machine learning model) to extract image features from the images 206′. The second stage may be another convolutional neural network, such as a regression-type network, to predict facial action units 210 for from the image features that have been extracted.

The predicted facial action units 210 for the facial expression 202 of the wearer 102 of the HMD 100 may be retargeted (228) onto an avatar 230 corresponding to the face 104 of the wearer 102 to render the avatar 230 with this facial expression 202. Prior to rendering the avatar 230, postprocessing—such as average mean filtering—may be performed to smooth the predicted facial action units 210 to ensure that the resulting rendered avatar has a facial expression that appears more natural and lifelike, and not disjointed.

The result of facial action unit retargeting is thus an avatar 230 for the wearer 102. The avatar 230 has the same facial expression 202 as the wearer 102 insofar as the predicted facial action units 210 (as have been postprocessed for smoothing) accurately reflect the wearer 102's facial expression 202. The avatar 230 is rendered from the predicted facial action units 210 in this respect, and thus has a facial expression corresponding to the facial action units 210.

The avatar 230 for the wearer 102 of the HMD 100 may then be displayed (232). For example, the avatar 230 may be displayed on the HMDs worn by other users who are participating in the same XR environment as the wearer 102. If the facial action units 210 are predicted by the HMD 100 or by a host device, such as a desktop or laptop computer, to which the HMD 100 is communicatively coupled, the HMD 100 or host device may thus transmit the rendered avatar 230 to the HMDs or host devices of the other users participating in the XR environment. In this respect, it is said that the HMD 100 or the host device indirectly displays the avatar 230, insofar as the avatar 230 is transmitted for display on other HMDs.

In another implementation, however, the HMD 100 may itself display the avatar 230. In this respect, it is said that the HMD 100 or the host device directly displays the avatar 230. The process 200 can be repeated with capture (204) of the next set of facial images 206 (234).

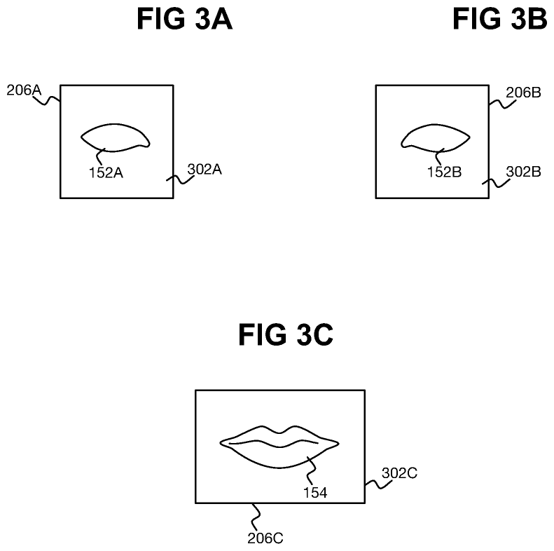

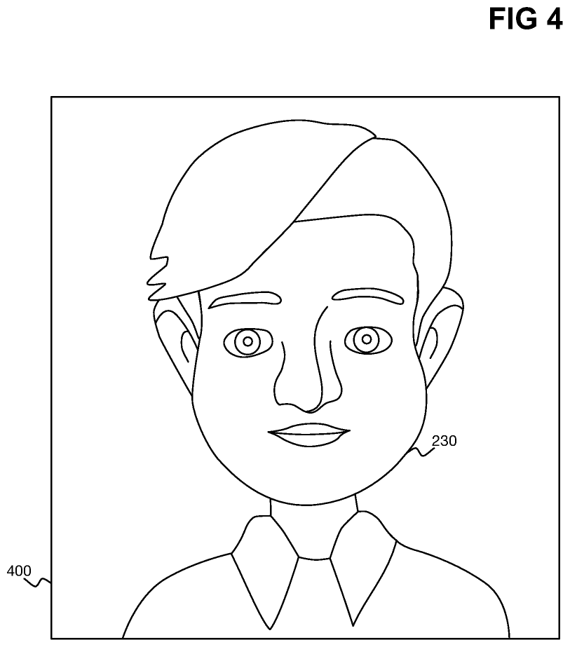

FIGS. 3A, 3B, and 3C show an example set of HMD-captured images 206A, 206B, and 206C, respectively, which are collectively referred to as and can constitute the images 206 to which the trained machine learning model 208 is applied to generate predicted facial action units 210. The image 206A is of a facial portion 302A including and surrounding the wearer 102's right eye 152A, whereas the image 206B is of a facial portion 302B including and surrounding the wearer 102's left eye 152B. The image 206C is of a lower facial portion 302C including and surrounding the wearer 102's mouth 154. FIGS. 3A, 3B, and 3C thus show examples of the types of images that can constitute the set of facial images 206 used to predict the facial action units 210.

FIG. 4 shows an example image 400 of an avatar 230 that can be rendered when retargeting the predicted facial action units 210 onto the avatar 230. In the example, the avatar 230 is a two-dimensional (2D) avatar, but it can also be a 3D avatar. The avatar 230 is rendered from the predicted facial action units 210 for the wearer 102's facial expression 202. Therefore, to the extent that the predicted facial action units 210 accurately encode the facial expression 202 of the wearer 102, the avatar 230 has the same facial expression 202 as the wearer 102.

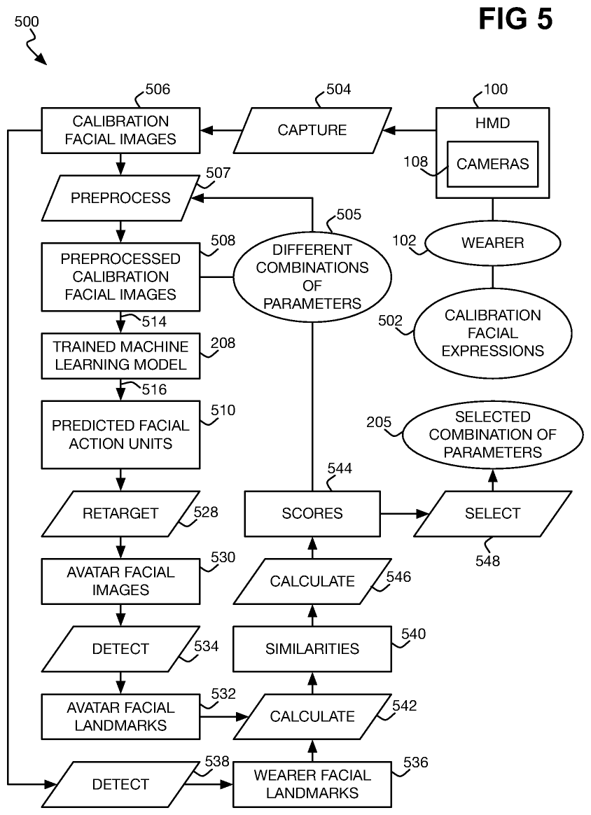

FIG. 5 shows an example process 500 for selecting the preprocessing parameters combination 205 to use in the process 200 for a particular wearer of 102 of the HMD 100. While the wearer 102 exhibits different calibration facial expressions 502, the cameras 108 of the HMD 100 capture (504) calibration facial images 506 under current lighting conditions. The facial expression 502 may include a neutral facial expression, a left-smile facial expression in which just the left corner of the mouth is curved upwards, and a right-smile facial expression in which just the right mouth corner is curved upwards. For each facial expression 502, there may be one or multiple facial images 506 that are captured.

There are multiple combinations 505 of the preprocessing parameters. For example, when the image-preprocessing technique is CLAHE, there may be multiple combinations 505 of grid size and clip limit. In this case, clip limit may be an integer between 0 and 10, and grid size may be an integer between 2 and 32. Because there are 11 different values for clip limit and 31 different values for grid size, this means that there can be up to 11×31=341 different parameter combinations 505.

Each calibration facial image 506 is independently preprocessed (507) using each different combination 505 of parameters to generate preprocessed calibration facial images 508 for each facial image 506. That is, the preprocessing technique in question is applied to each facial image 506 according to each different combination 505 to generate preprocessed calibration facial images 508 for each facial image 506. If there are N different combinations 505, this means that N preprocessed calibration facial images 508 are generated for each calibration facial image 506. If there are M facial images 506, this means that a total of M×N facial images 508 are generated.

The trained machine learning model 208 is applied (510) to each preprocessed calibration facial image 508 to generate a set of predicted facial action units 510 for each preprocessed calibration facial image 508. That is, each facial image 508 is input (514) into the model 208, with the model 208 outputting (516) a corresponding set of predicted facial action units 510 for that image 508. If there are M×N facial images 508, then there are M×N corresponding sets of predicted facial action units 510. The predicted facial action units 510 for a preprocessed calibration facial image 508 correspond to the calibration facial expression 502 exhibited by the wearer 102 within the calibration facial image 506 that was preprocessed to generate the preprocessed calibration facial image 508 in question.

Each set of predicted facial action units 510 can be retargeted (528) onto an avatar corresponding to the face 104 of the wearer 102 to render a corresponding avatar facial image 530. In the corresponding avatar facial image 530 rendering using a set of predicted facial action units 510, the avatar exhibits the calibration facial expression 502 to which these facial action units 510 correspond. How well the calibration facial expression 502 within the avatar facial image 530 matches the actual facial expression 502 exhibited by the wearer 102 depends on the accuracy of the machine learning model 208 in predicting the facial action units 510.

If there are M×N sets of predicted facial action units 510, there are M×N avatar facial images 530 corresponding to the M×N preprocessed calibration facial images 508. Specifically, there are N avatar facial images 530 corresponding to each of the M calibration facial images 506, where each of these N avatar facial images 530 corresponds to a different one of the N combinations 505 of parameters. Similarly, there are M avatar facial images 530 corresponding to each of the N combinations 505, where each of these M avatar facial images 530 corresponds to a different one of the M calibration facial images 506.

A set of avatar facial landmarks 532 is detected (534) within each avatar facial image 530. Therefore, M×N sets of avatar facial landmarks 532 are detected where there are M×N avatar facial images 530. A set of wearer facial landmarks 536 is likewise detected (538) within each (unprocessed) calibration facial image 506. Therefore, M sets of a wearer facial landmarks 536 are detected where there are M facial images 506. On one implementation, the PyTorch-based open source face landmark detection technique described at github.com/cunjian/pytorch_face_landmark can be used to detect the avatar facial landmarks 532 and the wearer facial landmarks 536.

A set of facial landmarks is a set of facial points that together can define a face appearing within an image. For example, a mouth shape is made up of a subset of the facial points for the lips of the mouth. Different facial models can use different sets of facial landmarks. For example, the technique described at https://ibug.doc.ic.ac.//resources/facial-point-annotations/ uses 68 facial landmarks, whereas the technique described at http://www.ifp.illinois./u/˜vuongle2/helen/ uses 194 facial landmarks. The locations of the facial landmarks according to a specified facial model are thus detected within an image to define the face appearing in that image.

A similarity 540 between each set of avatar facial landmarks 532 and its corresponding set of wearer facial landmarks 536 is calculated (542). For the set of avatar facial landmarks 532 detected within an avatar facial image 530, the corresponding set of wearer facial landmarks 536 is the set detected within the calibration facial image 506 corresponding to this avatar facial image 530. This calibration facial image 506 is that which was preprocessed to yield the preprocessed calibration facial image 508 to which the machine learning model 208 was applied to predict the facial action units 510 on which basis the avatar facial image 530 in question was rendered.

The similarity 540 between a set of avatar facial landmarks 532 and a corresponding set of wearer facial landmarks 536 is a proxy for how well the avatar facial image 530 matches the calibration facial expression 502 exhibited by the wearer 102 in the corresponding calibration facial image 506. Because the avatar facial image 530 is generated based on facial action units 510 predicted by the machine learning model 208 from a preprocessed calibration facial image 508, the similarity 540 is thus also a proxy of how accurate the model 208 is.

Furthermore, because a calibration facial image 506 is preprocessed a number of times, using a different combination 505 of parameters each time, some preprocessed calibration facial images 508 may result in the machine learning model 208 more accurately predicting facial action units 510 than other images 508. Therefore, the similarity 540 between a set of avatar facial landmarks 532 and a corresponding set of wearer facial landmarks 536 is also a proxy for how accurate the machine learning model 208 is when the calibration facial image 506 is preprocessed using a given parameter combination 505.

In one implementation, the similarities 540 are calculated using the Kabsch-Umeyama algorithm, which measures the similarity of two unaligned graphs of different scales in a scale-invariant manner. A graph is composed of a set of points. The Kabsch-Umeyama algorithm identifies the optimal translation, rotation, and scaling by minimizing the root-mean-square error (RMSE) of the two sets of points. The resulting RMSE between a set of avatar facial landmarks 532 and a corresponding set of wearer facial landmarks 536 is the similarity 540 between these two sets. The Kabsch-Umeyama algorithm is described in S. Umeyama et al., “Least-squares estimation of transformation parameters between two point patterns,” IEEE Transactions on Pattern Analysis and Machine Intelligence, vol. 13, iss. 4, pp. 376-380 (April 1991).

If there are M×N sets of avatar facial landmarks 532, then M×N similarities 540 are calculated. The set of wearer facial landmarks 536 for a given calibration facial image 506 is compared to each set of facial landmarks 532 detected from an avatar facial image 530 rendered using the facial action units 510 predicted from one of the preprocessed calibration facial images 508 generated from that facial image 506. Therefore, there are N similarities 540 calculated for each of the M calibration facial images 506, and there are M similarities 540 calculated for each of the N parameter combinations 505.

Scores 544 corresponding to the different combinations 505 of parameters are calculated (546) based on their calculated similarities 540 (544). The score 544 for each of the N parameter combinations 505 can be calculated as the sum of the M similarities 540 calculated for that parameter combination 505. The combination 205 of parameters that is then subsequently used in the process 200 is selected (548) from the parameter combinations 505 based on their scores 544.

Specifically, the combination 205 is selected as the combination 505 of preprocessing parameters yielding the highest similarity between the avatar facial landmarks 532 and the wearer facial landmarks 536. This is the combination 505 that has the highest or lowest score 544, depending on whether the calculation technique used to generate the similarities 540 generates a higher value for higher similarity or a lower value for lower similarity.

For a particular wearer 102 of the HMD 100, a preprocessing parameters combination 205 is thus selected in the process 500 for subsequent usage in the process 200. The combination 205 is selected using calibration facial images 506 of the wearer 102 that are captured under current lighting conditions as the wearer 102 exhibits different calibration facial expression 502. If the lighting conditions subsequently change, the process 500 may be repeated (either automatically or as initiated by the wearer 102) to select a different combination 205 from the combinations 505 to use in the process 200. The process 500 is performed at least once, however, for each different wearer 102.

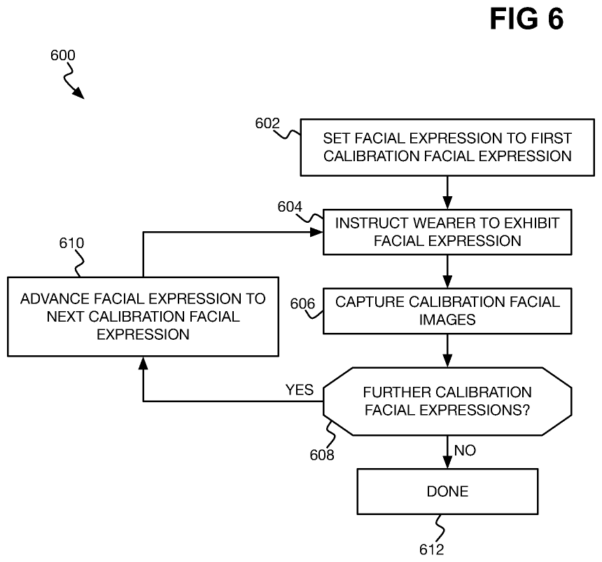

FIG. 6 shows an example method 600 for generating the calibration facial images 506 in the process 500. A facial expression is set to the first calibration facial expression 502 (602), and the HMD wearer 102 is instructed to exhibit this facial expression (604). While the HMD wearer 102 is exhibiting the facial expression, one or multiple of the calibration facial images 506 may be captured (606).

If there are other calibration facial expressions 502 that the wearer 102 has not yet been instructed to exhibit (608), then the process is repeated with the next calibration facial expression 502 (610). Once one or multiple facial images 506 of the wearer 102 have been captured for each calibration facial expression 502, the method 600 is finished (612). At completion of the method 600, therefore, there may be M total calibration facial expressions as has been noted.

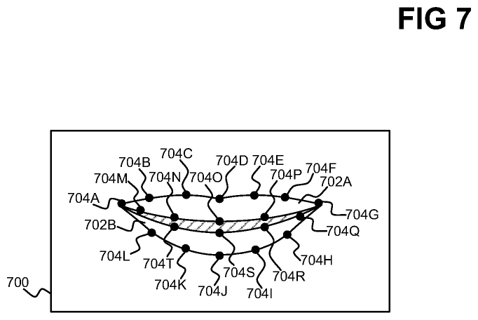

FIG. 7 shows example facial landmarks detected within a mouth image 700 including an upper lip 702A and a lower lip 702B. The mouth image 700 may be a part of or constitute the entirety of a calibration facial image 506 or an avatar facial image 530, for instance, within which wearer facial landmarks 536 or avatar facial landmarks 532 are respectively detected. In the depicted example, there are facial landmarks 704A, 704B, 704C, 704D, 704E, 704F, and 704G detected on the upper portion of the upper lip 702A. There are facial landmarks 704H, 704I, 704J, 704K, and 704L detected on the lower portion of the lower lip 702B. There are facial landmarks 704M 704N, 704O, and 704P detected on the lower portion of the upper lip 702A, and facial landmarks 704Q, 704R, 704S, and 704T detected on the upper portion of the lower lip 702B.

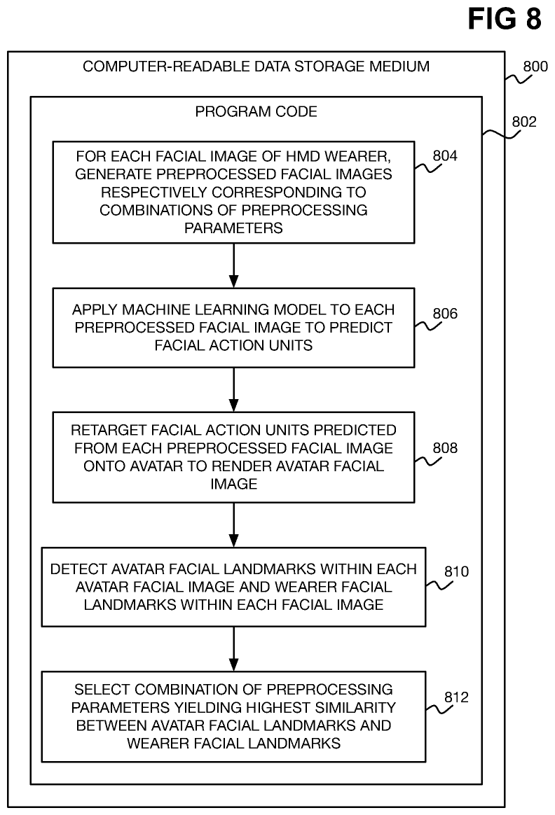

FIG. 8 shows an example non-transitory computer-readable data storage medium 800 storing program code 802 executable by a processor to perform processing. The processor may be part of the HMD 100 or part of a host computing device to which the HMD 100 is communicatively connected. The processing includes, for each of a number of facial images 506 of a wearer 102 of the HMD 100, generating a number of preprocessed facial images 508 respectively corresponding to combinations 505 of preprocessing parameters (804). The processing includes applying a machine learning model 208 to each preprocessed facial image 508 to predict facial action units 510 (806).

The processing includes retargeting the facial action units 510 predicted from each preprocessed facial image 508 onto an avatar to render one of a number of avatar facial images 530 (808). The processing includes detecting avatar facial landmarks 532 within each avatar facial image 530 and wearer facial landmarks 536 within each facial image 506 (810). The processing includes selecting the combination 205 of preprocessing parameters yielding a highest similarity between the avatar facial landmarks 532 and the wearer facial landmarks 536 corresponding to the avatar facial landmarks 532 (812).

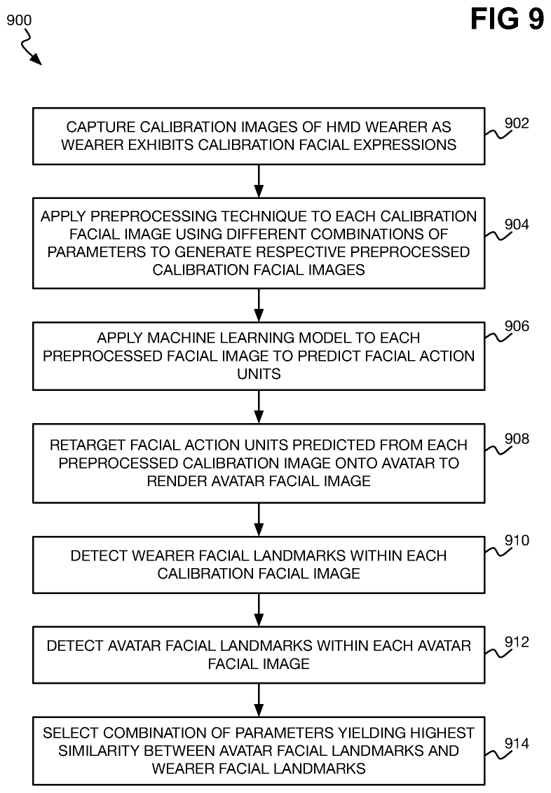

FIG. 9 shows an example method 900. The method 900 may be implemented as program code stored on a non-transitory computer-readable data storage medium and executed by a processor. The method 900 includes capturing, using one or multiple cameras 108 of an HMD 100, a number of calibration facial images 506 of a wearer 102 of the HMD 100 as the wearer 102 exhibits calibration facial expressions 502 (902). The method 900 includes applying a preprocessing technique to each calibration facial image 506 using a number of combinations 505 of parameters to generate a number of preprocessed calibration facial images 508 respectively corresponding to the combinations 505 (904).

The method 900 includes applying a machine learning model 208 to each preprocessed calibration facial image 508 to predict facial action units 510 corresponding to the calibration facial expression 502 exhibited by the wearer 102 in the calibration facial image 506 corresponding to the preprocessed calibration facial image 508 (906). The method 900 includes retargeting the facial action units 510 predicted from each preprocessed calibration facial image 508 onto an avatar to render one of a number of avatar facial images 530 in which the avatar exhibits the calibration facial expression 502 exhibited by the wearer 102 in the calibration facial image 506 corresponding to the preprocessed calibration facial image 508 (908).

The method 900 includes detecting wearer facial landmarks 536 within each calibration facial image 506 according to a specified facial model (910). The method 900 includes detecting avatar facial landmarks 532 within each avatar facial image 530 according to the specified facial model and that correspond to the wearer facial landmarks 536 detected within the calibration facial image 506 corresponding to the avatar facial image 530 (912). The method 900 includes selecting the combination 205 of parameters yielding a highest similarity between the avatar facial landmarks 532 and the wearer facial landmarks 536 corresponding to the avatar facial landmarks 532 (914).

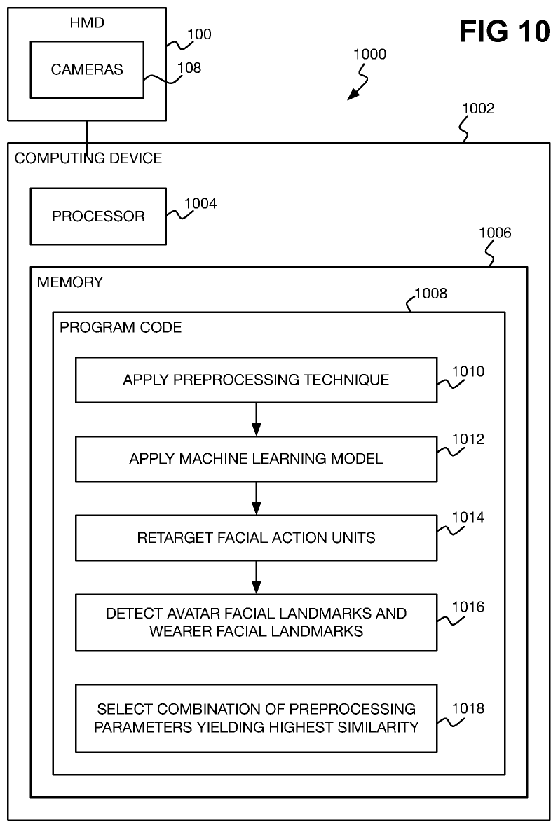

FIG. 10 shows an example system 1000. The system 1000 is depicted as including the HMD 100 and a computing device 1002. The HMD 100 one or multiple cameras 108 to capture a set of calibration facial images 506 of a wearer 102 of the HMD 100. The computing device 1002 has a processor 1004 and a memory 1006 storing program code 1008. The computing device 1002 may be the host device of the HMD 100, for instance. In another implementation, however the processor 1004 and the memory 1006 may be part of the HMD 100. In this case, the processor 1004 and the memory 1006 may be integrated within an application-specific integrated circuit (ASIC), such that the processor 1004 is a special-purpose processor. The processor 1004 may instead be a general-purpose processor, such as a central processing unit (CPU), such that the memory 1006 may be a separate semiconductor or other type of volatile or non-volatile memory 1006.

The program code 1008 is executable by the processor 1004 to perform processing. The processing includes applying a preprocessing technique to each calibration facial image 506 using a number of combinations 205 of parameters to generate preprocessed facial images 508 respectively corresponding to the combinations 205 (1010). The processing includes applying a machine learning model 208 to each preprocessed facial image 508 to predict facial action units 510 (1012), and retargeting the facial action units 510 predicted from each preprocessed facial image 508 onto an avatar to render one of a number of avatar facial images 530 (1014). The processing includes detect avatar facial landmarks 532 within each avatar facial image 530 and wearer facial landmarks 536 within each facial image 506 (1016). The processing includes select the combination 205 of parameters yielding a highest similarity between the avatar facial landmarks 532 and the wearer facial landmarks 536 corresponding to the avatar facial landmarks 532 (1018).

Techniques have been described for selecting a combination of preprocessing parameters to use to preprocess captured images of the wearer of an HMD on which basis facial action units corresponding to the facial expression exhibited by the wearer within the images are predicted. The selected combination can result in more accurately predicted facial action units, because they are specific to the wearer of the HMD, and take into account the lighting conditions when calibration facial images were captured. If lighting conditions change, the parameter combination can be reselected to again increase the accuracy of the facial action units prediction.

We claim:

1. A non-transitory computer-readable data storage medium storing program code executable by a processor to perform processing comprising:
for each of a plurality of facial images of a wearer of a head-mountable display (HMD), generating a plurality of preprocessed facial images respectively corresponding to combinations of preprocessing parameters;
applying a machine learning model to each preprocessed facial image to predict facial action units;
retargeting the facial action units predicted from each preprocessed facial image onto an avatar to render one of a plurality of avatar facial images;
detecting avatar facial landmarks within each avatar facial image and wearer facial landmarks within each facial image; and
selecting the combination of preprocessing parameters yielding a highest similarity between the avatar facial landmarks and the wearer facial landmarks corresponding to the avatar facial landmarks.

2. The non-transitory computer-readable data storage medium of claim 1, wherein the processing further comprises:
preprocessing subsequent facial images of the wearer using the selected combination of preprocessing parameters;
applying the machine learning model to the preprocessed subsequent facial images to predict wearer facial action units for a facial expression of the wearer exhibited within the subsequent facial images; and
retargeting the wearer facial action units onto the avatar to render the avatar with the facial expression of the wearer for display.

3. The non-transitory computer-readable data storage medium of claim 2, wherein the processing further comprises:
displaying the rendered avatar.

4. The non-transitory computer-readable data storage medium of claim 1, wherein the processing further comprises:
instructing the wearer to exhibit specified different calibration facial expressions; and
capturing, using one or multiple cameras of the HMD, one or more of the facial images while the wearer is exhibiting each specified different calibration facial expression.

5. The non-transitory computer-readable data storage medium of claim 1, wherein generating the preprocessed facial images for each facial image comprises:
independently applying a preprocessing technique to the facial image a plurality of times to generate the preprocessed facial images,
wherein a different combination of preprocessing parameters is used each time the preprocessing technique is applied.

6. The non-transitory computer-readable data storage medium of claim 1, further comprising:
for each avatar facial image, calculating a similarity between the avatar facial landmarks detected within the avatar facial image and the wearer facial landmarks detected within the facial image corresponding to the avatar facial image; and
calculating a score for each combination of preprocessing parameters based on the similarity for each avatar facial image corresponding to the combination of preprocessing parameters,
wherein the combination of preprocessing parameters having a highest or lowest score is selected as the combination of preprocessing parameters yielding the highest similarity.

7. A method comprising:
capturing, using one or multiple cameras of a head-mountable display (HMD), a plurality of calibration facial images of a wearer of the HMD as the wearer exhibits calibration facial expressions;
applying a preprocessing technique to each calibration facial image using a plurality of combinations of parameters to generate a plurality of preprocessed calibration facial images respectively corresponding to the combinations;
applying a machine learning model to each preprocessed calibration facial image to predict facial action units corresponding to the calibration facial expression exhibited by the wearer in the calibration facial image corresponding to the preprocessed calibration facial image;
retargeting the facial action units predicted from each preprocessed calibration facial image onto an avatar to render one of a plurality of avatar facial images in which the avatar exhibits the calibration facial expression exhibited by the wearer in the calibration facial image corresponding to the preprocessed calibration facial image;
detecting wearer facial landmarks within each calibration facial image according to a specified facial model;
detecting avatar facial landmarks within each avatar facial image according to the specified facial model and that correspond to the wearer facial landmarks detected within the calibration facial image corresponding to the avatar facial image; and
selecting the combination of parameters yielding a highest similarity between the avatar facial landmarks and the wearer facial landmarks corresponding to the avatar facial landmarks.

8. The method of claim 7, further comprising:
capturing, using the cameras of the HMD, facial images as the wearer exhibits a facial expression;
applying the preprocessing technique to the captured facial images using the selected combination of parameters;
applying the machine learning model to the captured facial images as have been preprocessed to predict wearer facial action units for the facial expression exhibited by the wearer within the captured facial images; and
retargeting the wearer facial action units onto the avatar to render the avatar with the facial expression of the wearer for display.

9. The method of claim 7, wherein the calibration facial expressions comprise a neutral facial expression, a left-smile facial expression, and a right-smile facial expression,
and wherein one or more of the calibration facial images are captured for each calibration facial expression.

10. The method of claim 7, wherein the preprocessing technique comprises contrast-limited adaptive histogram equalization,
and wherein the preprocessing parameters comprise clip limit and grid size.

11. The method of claim 7, further comprising:
for each avatar facial image, calculating a similarity between the avatar facial landmarks detected within the avatar facial image and the wearer facial landmarks detected within the calibration facial image corresponding to the avatar facial image; and
calculating a score for each combination of parameters based on the similarity for each avatar facial image corresponding to the combination of parameters,
wherein the combination of parameters having a highest or lowest score is selected as the combination of parameters yielding the highest similarity.

12. A system comprising:
a head-mountable display (HMD) having one or multiple cameras to capture calibration facial images of a wearer of the HMD as the wearer exhibits calibration facial expressions;
a processor; and
a memory storing program code executable by the processor to:
apply a preprocessing technique to each calibration facial image using a plurality of combinations of parameters to generate preprocessed facial images respectively corresponding to the combinations;
apply a machine learning model to each preprocessed facial image to predict facial action units;
retarget the facial action units predicted from each preprocessed facial image onto an avatar to render one of a plurality of avatar facial images;
detect avatar facial landmarks within each avatar facial image and wearer facial landmarks within each facial image; and
select the combination of parameters yielding a highest similarity between the avatar facial landmarks and the wearer facial landmarks corresponding to the avatar facial landmarks.

13. The system of claim 12, wherein the program code is executable by the processor to further:
apply the preprocessing technique to subsequently captured facial images of the wearer using the selected combination of parameters;
apply the machine learning model to the subsequently captured facial images as have been preprocessed to predict wearer facial action units for a facial expression exhibited by the wearer within the captured facial images; and
retarget the wearer facial action units onto the avatar to render the avatar with the facial expression of the wearer for display.

14. The system of claim 12, wherein the preprocessing technique comprises contrast-limited adaptive histogram equalization,
and wherein the preprocessing parameters comprise clip limit and grid size.

15. The system of claim 12, wherein the program code is executable by the processor to further:
for each avatar facial image, calculate a similarity between the avatar facial landmarks detected within the avatar facial image and the wearer facial landmarks detected within the calibration facial image corresponding to the avatar facial image; and
calculating a score for each combination of parameters based on the similarity for each avatar facial image corresponding to the combination of parameters,
wherein the combination of parameters having a highest or lowest score is selected as the combination of parameters yielding the highest similarity.
